(19) United States
(12) Patent Application Publication
(10) Pub. No.: US 2016/0168910 A1
(43) Pub. Date: Jun. 16, 2016

(54) APPARATUS FOR TRESTLE LADDER

(71) Applicant: Roderick Alexander KIRBY, Parksville (CA)

(72) Inventor: Roderick Alexander KIRBY, Parksville (CA)

(21) Appl. No.: 14/569,117

(22) Filed: Dec. 12, 2014

(51) Int. Cl. E06C 7/16; E06C 7/14; E06C 7/18

(52) U.S. Cl. CPC E06C 7/16; E06C 7/182; E06C 7/14

(57) ABSTRACT

An apparatus is for a user, and is for a trestle ladder. The trestle ladder has opposed trestle-ladder sides. Each of the opposed trestle-ladder sides includes trestle-ladder steps extending vertically along the opposed trestle-ladder sides. In accordance with an embodiment, the apparatus includes a combination of a user-support platform and a platform-connection assembly. The user-support platform is configured to support the user of the trestle ladder. The platform-connection assembly extends from the user-support platform. The platform-connection assembly is configured to connect to the trestle-ladder steps located on the opposed trestle-ladder sides of the trestle ladder.

### TECHNICAL FIELD

Some aspects generally relate to (and are not limited to) an apparatus for a trestle ladder.

### BACKGROUND

A trestle ladder is a self-supporting portable ladder, nonadjustable in length, and includes two opposed sections hinged at a top section to form equal angles with a base. The size of the trestle ladder is designated by the length of the side rails measured along a front edge. The trestle ladder forms an A-frame-style ladder (when unfolded and deployed). Sometimes, the trestle ladder is paired with another trestle ladder in such a way that, in combination, the two instances of the trestle ladder form part of a portable scaffold system. The trestle ladder may be called a foldable sawhorse or a foldable trestle ladder (once configured to be foldable).

### SUMMARY

It will be appreciated that there exists a need to mitigate (at least in part) at least one problem associated with existing trestle ladders. After much study of the known systems and methods with experimentation, an understanding of the problem and its solution has been identified and is articulated as follows:

Sometimes, users may attempt to stand upright on the trestle ladder while attempting to perform work, and this may lead to inadvertent accidents for the user and/or unwanted damage to the equipment (or to the trestle ladder).

To mitigate, at least in part, at least one problem associated with existing trestle ladders, there is provided (in accordance with a major aspect) an apparatus. The apparatus is for a user, and is for a trestle ladder. The trestle ladder has opposed trestle-ladder sides. Each of the opposed trestle-ladder sides includes trestle-ladder steps extending vertically along the opposed trestle-ladder sides. In accordance with an embodiment, the apparatus includes a combination of a user-support platform and a platform-connection assembly. The user-support platform is configured to support the user of the trestle ladder. The platform-connection assembly extends from the user-support platform. The platform-connection assembly is configured to connect to the trestle-ladder steps located on the opposed trestle-ladder sides of the trestle ladder.

To mitigate, at least in part, at least one problem associated with existing trestle ladders, there is provided (in accordance with a major aspect) an apparatus. The apparatus is for a user. In accordance with an embodiment, the apparatus includes a combination of a trestle ladder, a user-support platform and a platform-connection assembly. The trestle ladder has opposed trestle-ladder sides. Each of the opposed trestle-ladder sides includes trestle-ladder steps extending vertically along the opposed trestle-ladder sides. The user-support platform is configured to support the user of the trestle ladder. The platform-connection assembly extends from the user-support platform. The platform-connection assembly is configured to connect to the trestle-ladder steps located on the opposed trestle-ladder sides of the trestle ladder.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIGS. 1A and 1B (SHEET 1 OF 9 SHEETS) depict views of embodiments of an apparatus for a user and for a trestle ladder;

FIGS. 2A, 2B, 2C and 2D (SHEET 2 OF 9 SHEETS) depict views of embodiments of the apparatus of any one of FIGS. 1A, 1B, 1C and 1D;

FIGS. 3A, 3B and 3C (SHEETS 3 AND 4 OF 9 SHEETS) depict views of embodiments of the apparatus of any one of FIGS. 1A, 1B, 1C and 1D;

FIGS. 4A and 4B (SHEET 5 OF 9 SHEETS) depict views of embodiments of the apparatus of any one of FIGS. 1A, 1B, 1C and 1D;

FIGS. 5A, 5B, 5C, 5D and 5E (SHEETS 6 TO 8 OF 9 SHEETS) depict views of embodiments of the apparatus of any one of FIGS. 1A, 1B, 1C and 1D; and

FIG. 6 (SHEET 9 OF 9 SHEETS) depicts a view of an embodiment of the apparatus of any one of FIGS. 1A, 1B, 1C and 1D.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 user-support platform
104 platform-connection assembly
106 first step-engagement portion
108 second step-engagement portion
110 outer peripheral edge
112 toe guard
114 elongated jagged-edge member
116 elongated structural-support member
118 tool-tray assembly
120 extension assembly
122 interface assembly
124 guard-rail assembly
126 vertically-extending member
128 horizontally-extending member
130 pivot connector
900 user
902 trestle ladder
904 opposed trestle-ladder sides
906 trestle-ladder steps
908 work surface

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

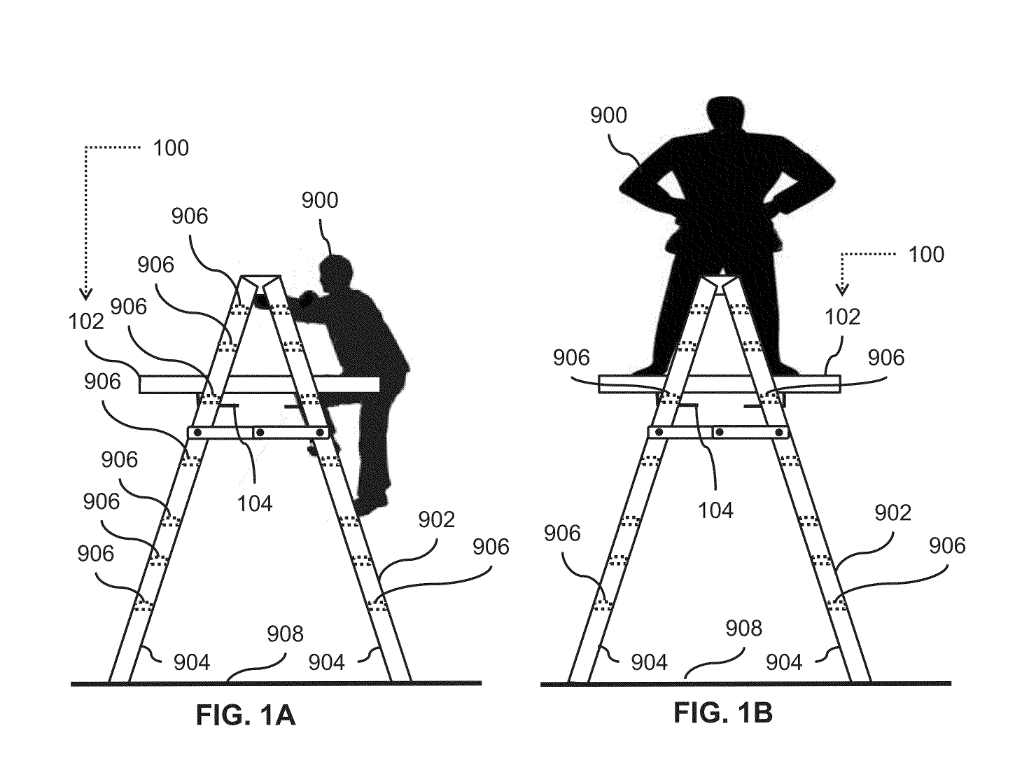

FIGS. 1A and 1B depict views of embodiments of an apparatus 100 for a user 900 and for a trestle ladder 902. FIGS. 1A and 1B depict side views.

In accordance with a first major exemplary embodiment, there is provided an apparatus 100. The apparatus 100 is for a user 900. The apparatus 100 is also for a trestle ladder 902. The trestle ladder 902 has opposed trestle-ladder sides 904. Each of the opposed trestle-ladder sides 904 includes trestle-ladder steps 906 extending vertically along the opposed trestle-ladder sides 904. In accordance with a first major exemplary embodiment, the apparatus 100 includes a combination of a user-support platform 102 and a platform-connection assembly 104. The user-support platform 102 may be called a work platform or a step extension. The user-support platform 102 is configured to support the user 900 of the trestle ladder 902. The platform-connection assembly 104 extends from the user-support platform 102. The platform-connection assembly 104 is configured to connect to the trestle-ladder steps 906 located on the opposed trestle-ladder sides 904 of the trestle ladder 902. Preferably, the user-support platform 102 extends past (beyond) each of the trestle-ladder steps 906 located on the opposite sides of the trestle ladder 902.

In accordance with a second major exemplary embodiment, there is provided an apparatus 100. The apparatus 100 is for the user 900. In accordance with the second major exemplary embodiment, the apparatus 100 includes a combination of the trestle ladder 902, the user-support platform 102 and the platform-connection assembly 104. The trestle ladder 902 has opposed trestle-ladder sides 904. Each of the opposed trestle-ladder sides 904 includes trestle-ladder steps 906 extending vertically along the opposed trestle-ladder sides 904. The user-support platform 102 is configured to support the user 900 of the trestle ladder 902. The platform-connection assembly 104 extends from the user-support platform 102. The platform-connection assembly 104 is configured to connect to the trestle-ladder steps 906 located on the opposed trestle-ladder sides 904 of the trestle ladder 902.

The trestle ladder 902 may be called a foldable sawhorse or a foldable trestle ladder. For instance, the height of the trestle ladder 902 is in the range from about three feet to about 10 feet. The trestle ladder 902 is configured to be positioned or placed in a closed position (also called a storage position, and is depicted in FIG. 1A) and a fully open position (also called a deployed position, and is depicted in FIG. 1B). The trestle ladder 902 is positioned on a work surface 908.

In accordance with a preferred embodiment, the user-support platform 102 is configured to be placed (positioned) on the third instance of the trestle-ladder steps 906 that are located below the top section of the trestle ladder 902. This may be a legislated requirement.

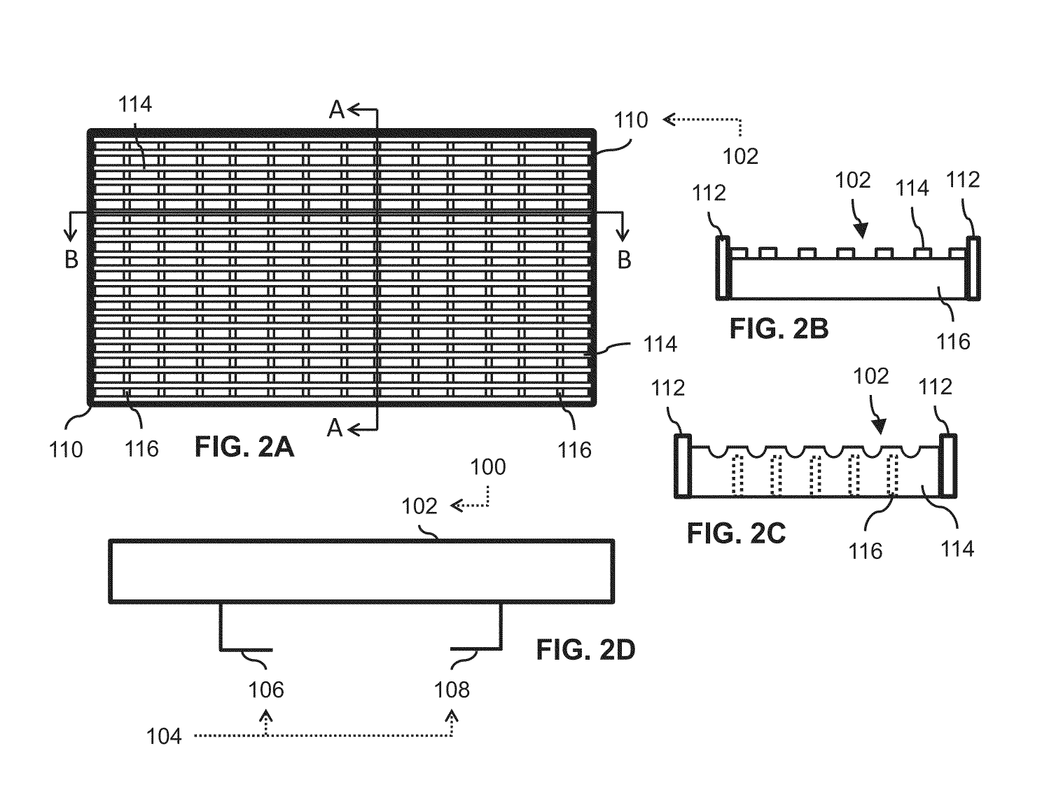

FIGS. 2A, 2B, 2C and 2D depict views of embodiments of the apparatus 100 of any one of FIGS. 1A, 1B, 1C and 1D. FIG. 2A depicts a top view. FIG. 2B depicts a cross-sectional view through a cross-sectional line A-A of FIG. 2A. FIG. 2C depicts a cross-sectional view through a cross-sectional line B-B of FIG. 2A. FIG. 2D depicts a side view.

In accordance with an embodiment depicted in FIGS. 2B and 2C, the user-support platform 102 includes an outer peripheral edge 110, and a toe guard 112 positioned along the outer peripheral edge 110. The toe guard 112 extends above a central midsection of the user-support platform 102. The toe guard 112 is configured to prevent inadvertent slippage of footwear of the user 900 (depicted in FIG. 1B) from the central midsection of the user-support platform 102 (while the user is standing on the user-support platform 102 as depicted in FIG. 1B).

In accordance with an embodiment, the user-support platform 102 includes instances of an elongated jagged-edge member 114 extending across the opposite sides of the user-support platform 102. The elongated jagged-edge member 114 is configured to provide a jagged edge that further enhances secured engagement between footwear of the user 900 (depicted in FIG. 1B) and the user-support platform 102. The instances of the elongated jagged-edge member 114 are spaced apart from each other, and are positioned parallel relative to each other.

In accordance with an embodiment, the user-support platform 102 includes instances of an elongated structural-support member 116 extending across opposite sides of the user-support platform 102. The elongated structural-support member 116 is configured to provide structural support to the user-support platform 102. The instances of the elongated structural-support member 116 and the instances of an elongated jagged-edge member 114 are aligned orthogonally relative to each other.

In accordance with an embodiment depicted in FIG. 2D, the platform-connection assembly 104 is adapted to include a combination of a first step-engagement portion 106 and a second step-engagement portion 108. The second step-engagement portion 108 is spaced apart from the first step-engagement portion 106. The first step-engagement portion 106 and the second step-engagement portion 108 fixedly extend from the user-support platform 102. The first step-engagement portion 106 and the second step-engagement portion 108 are configured to slidably engage with respective instances of the trestle-ladder steps 906 located on opposite sides of the trestle ladder 902 (as depicted in FIG. 1B).

As depicted, the first step-engagement portion 106 and the second step-engagement portion 108 form an open channel C-shaped section or formation. The first step-engagement portion 106 and the second step-engagement portion 108 are welded (fixedly connected) to a bottom portion of the user-support platform 102. The first step-engagement portion 106 and the second step-engagement portion 108 are configured to slidably receive the trestle-ladder steps 906 depicted in FIG. 1B. It will be appreciated that once the user-support platform 102 is installed to the trestle ladder 902 as depicted in FIG. 1B, the weight of the user 900 is applied to the user-support platform 102. The weight of the user 900 securely positions the user-support platform 102 to the trestle-ladder steps 906. The weight of the user 900 prevents the user-support platform 102 from becoming inadvertently moved. Once the user 900 steps off the user-support platform 102, the user-support platform 102 may be repositioned relative to the trestle-ladder steps 906 (shifted around) or may be moved away from the trestle ladder 902 (as may be required).

In accordance with an embodiment, the first step-engagement portion 106 and the second step-engagement portion 108 are configured to accommodate the trestle-ladder steps 906 of any one of a four-foot configuration of the trestle ladder 902, a five-foot configuration of the trestle ladder 902, a six-foot configuration of the trestle ladder 902, a seven-foot configuration of the trestle ladder 902, an eight-foot configuration of the trestle ladder 902, and a ten-foot configuration of the trestle ladder 902.

In accordance with an embodiment, the first step-engagement portion 106 and the second step-engagement portion 108 include an angle arm (and any equivalent).

In accordance with an embodiment, the first step-engagement portion 106 and the second step-engagement portion 108 include a structural-reinforcement member, such as a flat bar (and any equivalent).

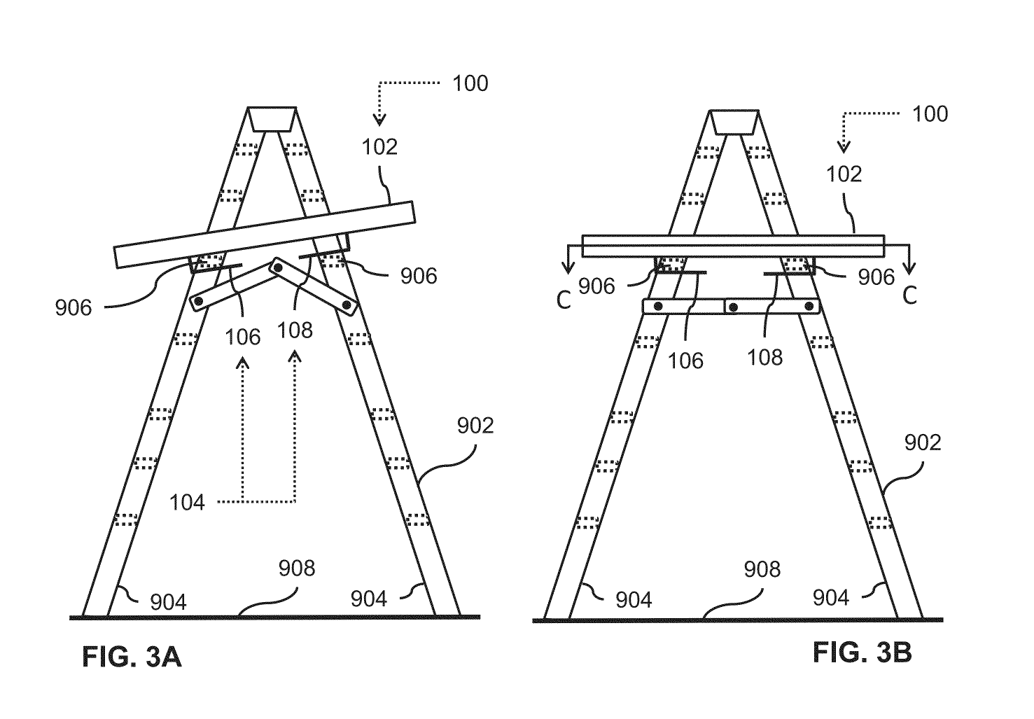

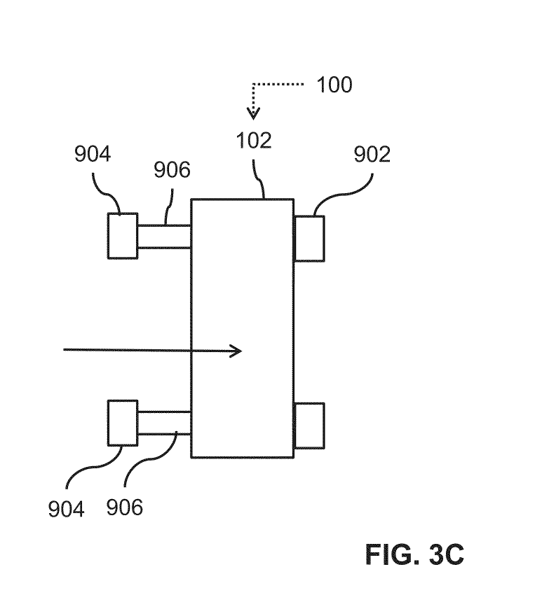

FIGS. 3A, 3B and 3C depict views of embodiments of the apparatus 100 of any one of FIGS. 1A, 1B, 1C and 1D. FIGS. 3A and 3B depict side views. FIG. 3C depicts a cross-sectional view through a cross-sectional line C-C of FIG. 3A.

Referring to the embodiments depicted in FIGS. 3A and 3B, the user-support platform 102 is installed to the trestle ladder 902 by using a combination of operations, including an operation (A), an operation (B), and an operation (C).

The operation (A) includes partly opening (partly unfolding) the trestle ladder 902. The trestle ladder 902 is not fully opened.

The operation (B) includes placing (positioning) the user-support platform 102 onto the trestle-ladder steps 906 that are positioned on the opposed trestle-ladder sides 904 of the trestle ladder 902. This is done in such a way that the first step-engagement portion 106 faces toward the trestle-ladder steps 906, and the second step-engagement portion 108 faces toward the trestle-ladder steps 906.

The operation (C) includes fully opening (fully unfolding) the trestle ladder 902. This is done in such a way that the first step-engagement portion 106 slidably engages the trestle-ladder steps 906, and the second step-engagement portion 108 slidably engages the trestle-ladder steps 906 as the trestle ladder 902 is positioned in the fully opened position.

FIG. 3A depicts the trestle ladder 902 ready for mounting (for installation) of the user-support platform 102. FIG. 3B depicts the trestle ladder 902 in the deployed position.

Referring to FIG. 3B, it will be appreciated that the weight of the user locks the platform into position. In accordance with an embodiment, the apparatus 100 includes a lock assembly (known and not depicted) configured to spatially lock the user-support platform 102 to the trestle-ladder steps 906.

Referring to FIG. 3C, the user-support platform 102 is positioned to one side of the trestle ladder 902 in such way that a portion of the trestle-ladder steps 906 is available for user access.

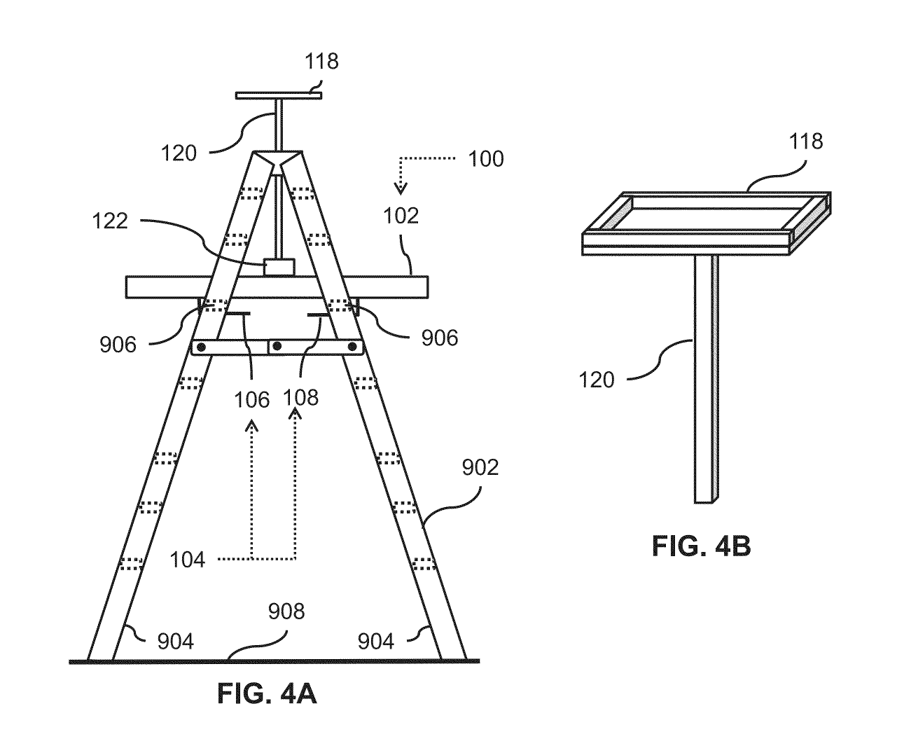

FIGS. 4A and 4B depict views of embodiments of the apparatus 100 of any one of FIGS. 1A, 1B, 1C and 1D. FIG. 4A depicts a side view. FIG. 4B depicts a perspective view.

In accordance with the embodiments depicted in FIGS. 4A and 4B, the apparatus 100 further includes a combination of a tool-tray assembly 118, an extension assembly 120, and an interface assembly 122. The interface assembly 122 is configured to interface the extension assembly 120 to the user-support platform 102. The extension assembly 120 is configured to receive and support the tool-tray assembly 118. The tool-tray assembly 118 is configured to receive tools (in a safe manner).

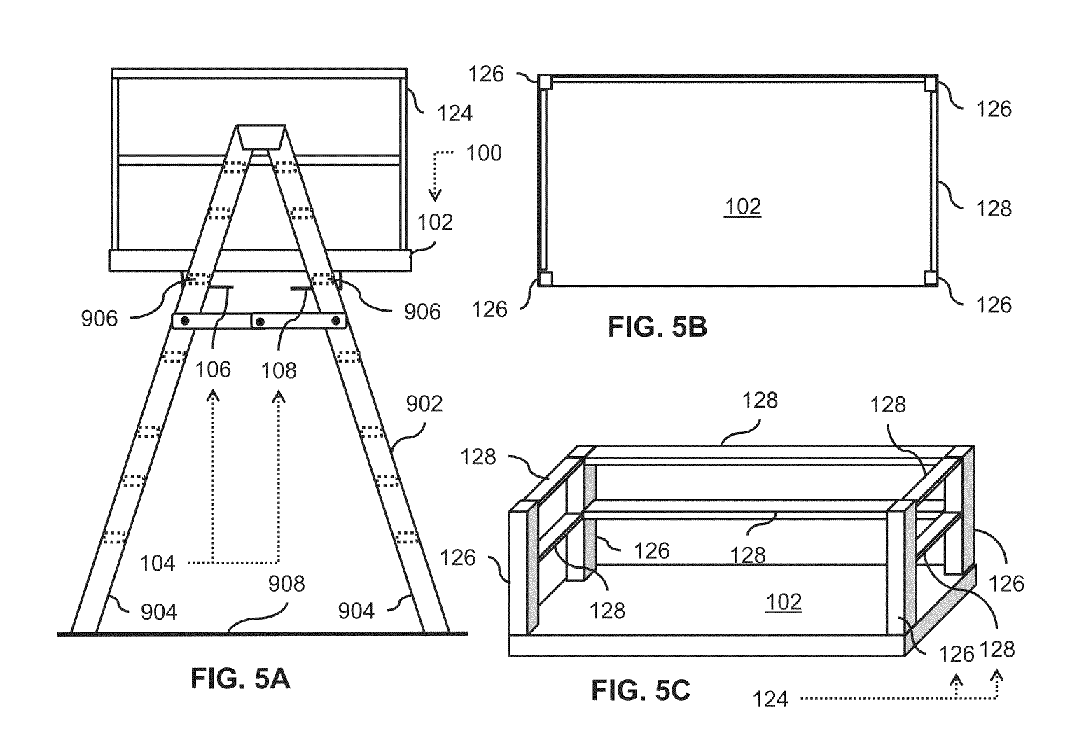

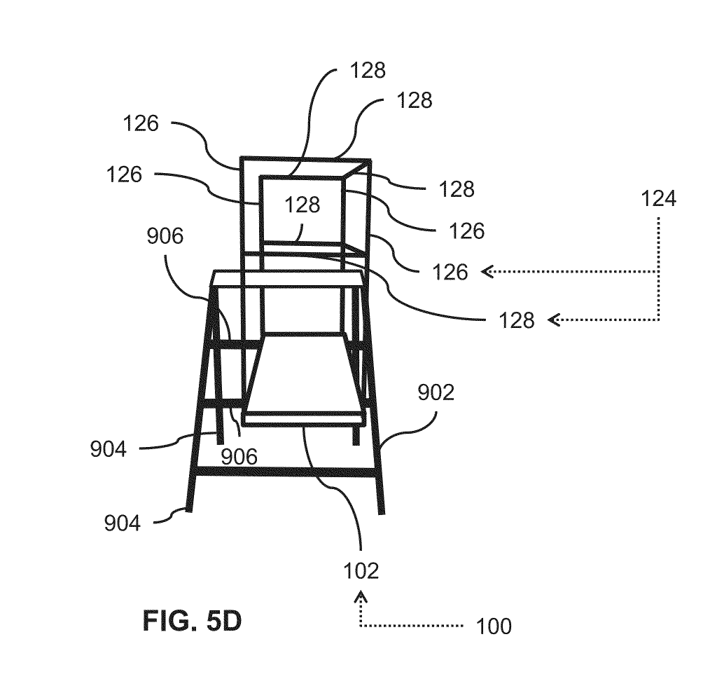

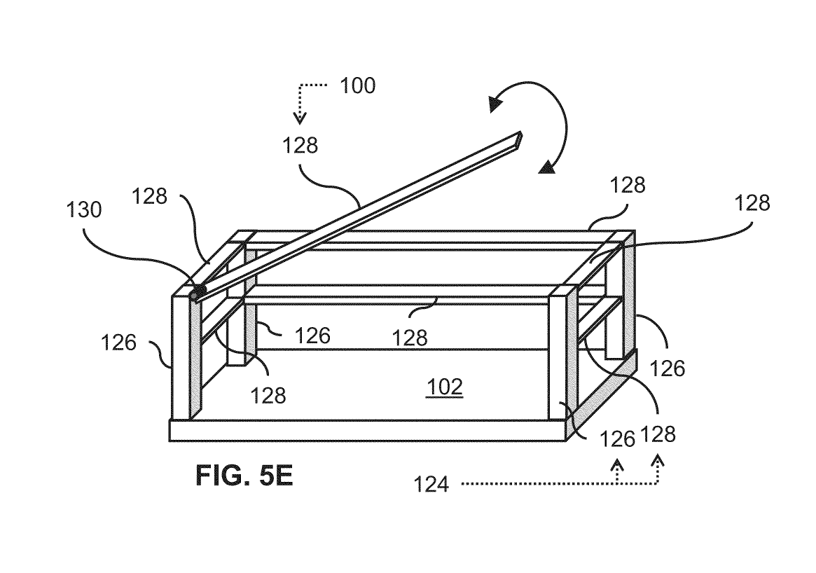

FIGS. 5A, 5B, 5C, 5D and 5E depict views of embodiments of the apparatus 100 of any one of FIGS. 1A, 1B, 1C and 1D. FIG. 5A depicts a side view. FIG. 5B depicts a top view. FIG. 5C depicts a perspective view. FIG. 5D depicts an end-side perspective view. FIG. 5E depicts a perspective view.

In accordance with the embodiments depicted in FIGS. 5A and 5B, the apparatus 100 further includes a guard-rail assembly 124 configured to be fixedly connectable to the user-support platform 102. The guard-rail assembly 124 is configured to surround at least in part (or at least three sides) of the user-support platform 102 (once installed to the user-support platform 102 to do just so). The guard-rail assembly 124 includes a combination of instances of a vertically-extending member 126 and instances of a horizontally-extending member 128. The instances of vertically-extending member 126 and the instances of a horizontally-extending member 128 are fixedly interconnectable with each other. The instances of a vertically-extending member 126 and the instances of a horizontally-extending member 128 may be pinned together or may be fixedly connectable with each other and with the user-support platform 102.

Referring to the embodiment depicted in FIG. 5E, an instance of the horizontally-extending member 128 is pivotally connected (via a pivot connector 130) to an instance of the vertically-extending member 126. This is done in such a way that the horizontally-extending member 128 pivotally moves between an open position and an closed position. In the closed position, the horizontally-extending member 128 is moved or positioned so that the interior zone of the user-support platform 102 is completely surrounded on all side by instances of the horizontally-extending member 128 (thereby safely surrounding the user standing on the user-support platform 102). In the closed positon, the horizontally-extending member 128 may be locked to the vertically-extending member 126 (if so desired). In the open position, the horizontally-extending member 128 is pivoted upwards (or moved away) in such w way that user access to the interior of the user-support platform 102 is permitted (to permit user access or egress from the user-support platform 102).

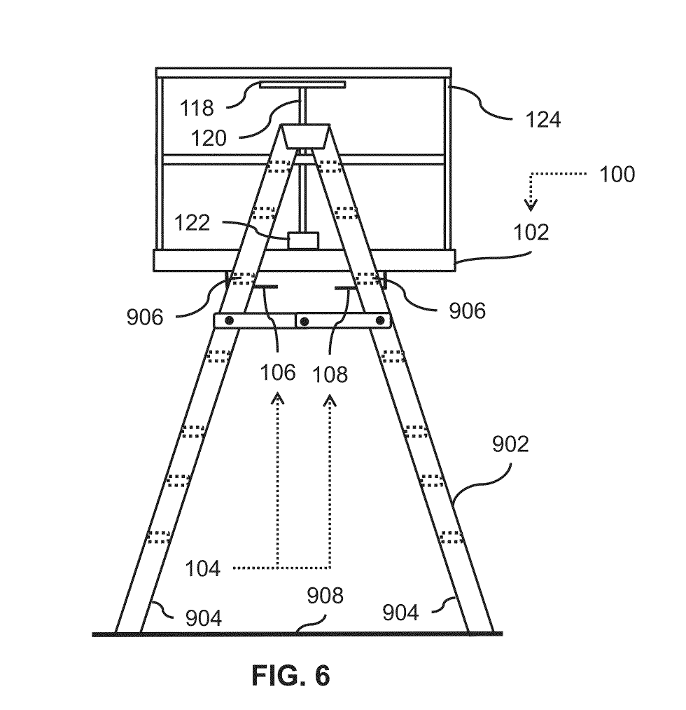

FIG. 6 depicts a view of an embodiment of the apparatus 100 of any one of FIGS. 1A, 1B, 1C and 1D. FIG. 6 depicts a side view.

In accordance with the embodiment depicted in FIG. 6, the apparatus 100 includes the tool-tray assembly 118, the extension assembly 120, the interface assembly 122, and the guard-rail assembly 124.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for a user and for a trestle ladder having opposed trestle-ladder sides, each of the opposed trestle-ladder sides including trestle-ladder steps extending vertically along the opposed trestle-ladder sides, the apparatus comprising:
a user-support platform being configured to support the user of the trestle ladder; and
a platform-connection assembly extending from the user-support platform, and the platform-connection assembly being configured to connect to the trestle-ladder steps located on the opposed trestle-ladder sides of the trestle ladder.

2. The apparatus of claim 1, wherein:
the platform-connection assembly incudes:
a first step-engagement portion; and
a second step-engagement portion being spaced apart from the first step-engagement portion.

3. The apparatus of claim 2, wherein:
the first step-engagement portion and the second step-engagement portion fixedly extend from the user-support platform.

4. The apparatus of claim 2, wherein:
the first step-engagement portion and the second step-engagement portion are configured to slidably engage with respective instances of the trestle-ladder steps being located on opposite sides of the trestle ladder.

5. The apparatus of claim 2, wherein:
the first step-engagement portion and the second step-engagement portion fixedly extend from the user-support platform; and
the first step-engagement portion and the second step-engagement portion are configured to slidably engage with respective instances of the trestle-ladder steps being located on opposite sides of the trestle ladder.

6. The apparatus of claim 1, wherein:
the user-support platform is configured to be placed on a third instance of the trestle-ladder steps that is positioned from a top section of the trestle ladder.

7. The apparatus of claim 1, wherein:
the user-support platform includes:
an outer peripheral edge; and
a toe guard positioned along the outer peripheral edge;
the toe guard extends above a central midsection of the user-support platform;
and
the toe guard is configured to prevent inadvertent slippage of footwear of the user from the central midsection of the user-support platform.

8. The apparatus of claim 1, wherein:
the user-support platform further includes:
instances of an elongated jagged-edge member extending across opposite sides of the user-support platform;
the elongated jagged-edge member being configured to provide a jagged edge that enhances secured engagement between footwear of the user and the user-support platform; and
the instances of the elongated jagged-edge member being spaced apart from each other, and being positioned parallel relative to each other.

9. The apparatus of claim 1, wherein:
the user-support platform further includes:
instances of an elongated structural-support member extending across opposite sides of the user-support platform;
the elongated structural-support member being configured to provide structural support to the user-support platform;
the instances of the elongated structural-support member and the instances of an elongated jagged-edge member are aligned orthogonally relative to each other.

10. The apparatus of claim 2, wherein:
the first step-engagement portion and the second step-engagement portion each forms an open channel C-shaped section;
the first step-engagement portion and the second step-engagement portion are fixedly connected to a bottom portion of the user-support platform; and
the first step-engagement portion and the second step-engagement portion are configured to slidably receive the trestle-ladder steps.

11. The apparatus of claim 1, wherein:
once the user-support platform is installed to the trestle ladder, a weight of the user is applied to the user-support platform, and the weight of the user securely positions the user-support platform to the trestle-ladder steps, and the weight of the user prevents the user-support platform from becoming inadvertently moved.

12. The apparatus of claim 2, wherein:
the first step-engagement portion and the second step-engagement portion are configured to accommodate the trestle-ladder steps of any one of a four-foot configuration of the trestle ladder, a five-foot configuration of the trestle ladder, a six-foot configuration of the trestle ladder, a seven-foot configuration of the trestle ladder, an eight-foot configuration of the trestle ladder, and a ten-foot configuration of the trestle ladder.

13. The apparatus of claim 2, wherein:
the first step-engagement portion and the second step-engagement portion include an angle arm.

14. The apparatus of claim 2, wherein:
the first step-engagement portion and the second step-engagement portion include a structural-reinforcement member.

15. The apparatus of claim 1, wherein:
the user-support platform is positioned to one side of the trestle ladder in such way that a portion of the trestle-ladder steps is available for user-access.

16. The apparatus of claim 1, further comprising:
a tool-tray assembly;
an extension assembly; and
an interface assembly being configured to interface the extension assembly to the user-support platform;
the extension assembly being configured to receive and support the tool-tray assembly; and
the tool-tray assembly being configured to receive tools.

17. The apparatus of claim 1, further comprising:
a guard-rail assembly being configured to be fixedly connectable to the user-support platform; and
the guard-rail assembly being configured to surround at least three sides of the user-support platform once installed to the user-support platform to do just so.

18. The apparatus of claim 17, wherein:
the guard-rail assembly includes a combination of instances of a vertically-extending member and instances of a horizontally-extending member being fixedly interconnectable with each other.

19. An apparatus for a user, the apparatus comprising:
a trestle ladder having opposed trestle-ladder sides, each of the opposed trestle-ladder sides including trestle-ladder steps extending vertically along the opposed trestle-ladder sides;
a user-support platform configured to support the user of the trestle ladder; and
a platform-connection assembly extending from the user-support platform, and the platform-connection assembly being configured to connect to the trestle-ladder steps located on the opposed trestle-ladder sides of the trestle ladder.

20. The apparatus of claim 19, further comprising:
a tool-tray assembly;
an extension assembly; and
an interface assembly being configured to interface the extension assembly to the user-support platform;
the extension assembly being configured to receive and support the tool-tray assembly; and
the tool-tray assembly being configured to receive tools; and
a guard-rail assembly being configured to be fixedly connectable to the user-support platform; and
the guard-rail assembly being configured to surround at least three sides of the user-support platform once installed to the user-support platform to do just so.
